(19) United States
(12) Patent Application Publication
(10) Pub. No.: US 2020/0303759 A1
(43) Pub. Date: Sep. 24, 2020

(54) FUEL CELL VEHICLE

(71) Applicant: HONDA MOTOR CO., LTD., Tokyo (JP)

(72) Inventors: Hideharu Naito, Wako-shi (JP); Masahiro Sato, Wako-shi (JP)

(21) Appl. No.: 16/819,231

(22) Filed: Mar. 16, 2020

(30) Foreign Application Priority Data
Mar. 18, 2019 (JP) 2019-050226

(51) Int. Cl. H01M 8/248

(52) U.S. Cl. CPC H01M 8/248; H01M 2250/20

(57) ABSTRACT

A fuel cell vehicle is equipped with a mounting bracket disposed with respect to an end plate. The end plate extends in a transverse direction which is perpendicular to a stacking direction and a vertical direction of a cell stack. In addition, the bracket is disposed near one end in the transverse direction of the end plate and at a portion on a lower side thereof, together with being formed in a triangular shape when viewed from the stacking direction.

### CROSS-REFERENCE TO RELATED APPLICATION

This application is based upon and claims the benefit of priority from Japanese Patent Application No. 2019-050226 filed on Mar. 18, 2019, the contents of which are incorporated herein by reference.

### BACKGROUND OF THE INVENTION

### Field of the Invention

The present invention relates to a fuel cell vehicle equipped with a fuel cell stack having an end plate that applies a tightening load with respect to a cell stack including a plurality of power generation cells that are stacked in a stacking direction of the cell stack.

### Description of the Related Art

For example, in Japanese Laid-Open Patent Publication No. 2017-074934, a configuration is disclosed in which a fuel cell stack is disposed in a front box (motor room) of a fuel cell vehicle. A mounting bracket (right side bracket) is fastened by bolts to an end plate of the fuel cell stack (see FIG. 3 of Japanese Laid-Open Patent Publication No. 2017-074934). In such a case, the end plate can be reinforced by the bracket.

### SUMMARY OF THE INVENTION

However, in above-described Japanese Laid-Open Patent Publication No. 2017-074934, the shape of the bracket as viewed from the stacking direction (vehicle widthwise direction) of the power generation cells, and the fastening position of the bracket in a vertical direction of the end plate are not shown.

Further, in the case that a fuel cell vehicle is involved in a collision, the fuel cell stack and the bracket move relative to the vehicle body inside the front box. More specifically, for example, in the case that the fuel cell vehicle is involved in a rear-end collision, the fuel cell stack and the bracket move relative to the vehicle body in a vehicle rearward direction inside the front box. Therefore, it is desirable that the bracket be provided on the fuel cell stack with a shape and position so as not to interfere with a vehicle body component at the time of a vehicle collision.

The present invention has been devised taking into consideration such a problem, and has the object of providing a fuel cell vehicle in which an end plate can easily be reinforced, and interference between a bracket and a vehicle component at the time of a vehicle collision can be effectively suppressed.

An aspect of the present invention is characterized by a fuel cell vehicle, the fuel cell vehicle comprising a fuel cell stack and a mounting bracket, the fuel cell stack having an end plate configured to apply a tightening load to a cell stack including a plurality of power generation cells that are mutually stacked, the tightening load being applied in a stacking direction of the cell stack, and the mounting bracket being provided for the end plate, wherein the fuel cell stack is disposed in a manner so that the stacking direction is oriented in a vehicle widthwise direction, the end plate extends in a transverse direction, and the bracket is disposed near one end in the transverse direction of the end plate and at a portion on a lower side thereof, the bracket being formed in a triangular shape when viewed from the stacking direction.

According to the present invention, since the bracket is provided on the end plate, the end plate can be easily reinforced by the bracket. Further, the bracket is disposed at a portion on the lower side near the one end in the transverse direction of the end plate, and is formed in a triangular shape when viewed from the stacking direction of the cell stack. Therefore, a comparatively wide space can be secured around the periphery of the bracket (in particular, on the other end side of the end plate in the transverse direction with respect to the bracket). Owing to this feature, the vehicle body component can be positioned in the aforementioned space around the periphery of the bracket at the time of a vehicle collision. Accordingly, interference between the bracket and the vehicle body component at the time of a vehicle collision can be effectively suppressed.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic structural explanatory view of a fuel cell vehicle according to an embodiment of the present invention;

FIG. 2 is an exploded perspective view with partial omission of a fuel cell stack and a bracket of FIG. 1 as viewed from a right side of the vehicle;

FIG. 3 is a plan view of the fuel cell stack and the bracket of FIG. 1 as viewed from the right side of the vehicle; and

FIG. 4 is an explanatory diagram showing a positional relationship between the bracket and a vehicle body component when the fuel cell stack is moved.

### DETAILED DESCRIPTION OF THE PREFERRED EMBODIMENTS

Hereinafter, a preferred embodiment of a fuel cell vehicle according to the present invention will be presented and described in detail below with reference to the accompanying drawings.

In each of the drawings, with a fuel cell vehicle 10 serving as a standard, as viewed from the perspective of the driver, a left side of the fuel cell vehicle 10 is indicated by the arrow “L”, a right side of the fuel cell vehicle 10 is indicated by the arrow “R”, a frontward direction (front side) of the fuel cell vehicle 10 is indicated by the arrow “Fr”, a rearward direction (rear side) of the fuel cell vehicle 10 is indicated by the arrow “Rr”, an upward direction of the fuel cell vehicle 10 is indicated by the arrow “U”, and a downward direction of the fuel cell vehicle 10 is indicated by the arrow “D”.

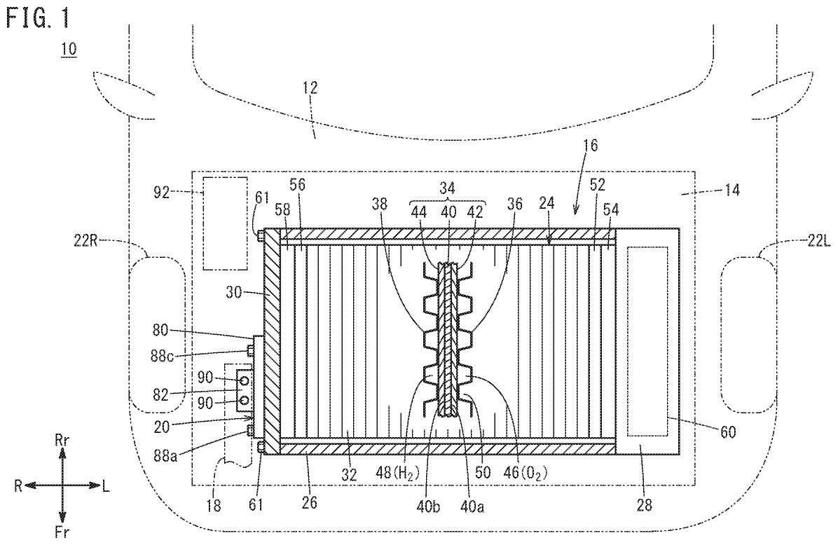

As shown in FIG. 1, the fuel cell vehicle 10 according to one embodiment of the present invention, for example, is a fuel cell electric vehicle. The fuel cell vehicle 10 is equipped with a fuel cell stack 16 disposed inside a front box 14 (motor room) that is formed in front (on a front side) of a dashboard 12, and a mounting bracket 20 for fixing the fuel cell stack 16 to a mounting member 18 (body frame). The front box 14 is provided between the left and right front wheels 22L and 22R. Inside the front box 14, in addition to the fuel cell stack 16, a non-illustrated motor for driving the vehicle is arranged.

The fuel cell stack 16 includes a cell stack 24, a stack case 26, an auxiliary equipment case 28, and an end plate 30. The cell stack 24 is formed by stacking a plurality of power generation cells 32 in one direction (a vehicle widthwise direction, a left/right transverse direction). Each of the power generation cells 32 includes a membrane electrode assembly 34, and a pair of separators 36 and 38 that sandwich the membrane electrode assembly 34 from both sides.

The membrane electrode assembly 34 includes, for example, a solid polymer electrolyte membrane 40, a cathode 42 provided on one surface 40a of the solid polymer electrolyte membrane 40, and an anode 44 provided on another surface 40b of the solid polymer electrolyte membrane 40. The solid polymer electrolyte membrane 40 is a thin membrane of perfluorosulfonic acid containing water. In addition to a fluorine based electrolyte, an HC (hydrocarbon) based electrolyte may be used for the solid polymer electrolyte membrane 40.

The separators 36 and 38 are made by press forming into a wavy or corrugated shape the cross sections of metal plates, for example, such as steel plates, stainless steel plates, aluminum plates, plated steel sheets, or metal plates having anti-corrosive surfaces produced by performing a surface treatment thereon. The separators 36 and 38 may be constituted by carbon members.

An oxygen-containing gas flow field 46 through which an oxygen-containing gas (for example, air) flows is formed on a surface of the separator 36 facing toward the cathode 42. A fuel gas flow field 48 through which a fuel gas (for example, hydrogen gas) flows is formed on a surface of the separator 38 facing toward the anode 44. A coolant flow field 50 through which a coolant flows is formed between mutually adjacent ones of the separators 36 and 38.

The oxygen-containing gas is supplied to the cathodes 42. The fuel gas is supplied to the anodes 44. The power generation cells 32 generate electrical power by electrochemical reactions taking place between the oxygen-containing gas supplied to the cathodes 42 and the fuel gas supplied to the anodes 44.

At one end (an end in the direction of the arrow L) in the stacking direction of the cell stack 24, a first terminal plate 52 and a first insulating plate 54 are sequentially arranged in an outward direction. At another end (an end in the direction of the arrow R) in the stacking direction of the cell stack 24, a second terminal plate 56 and a second insulating plate 58 are sequentially arranged in an outward direction.

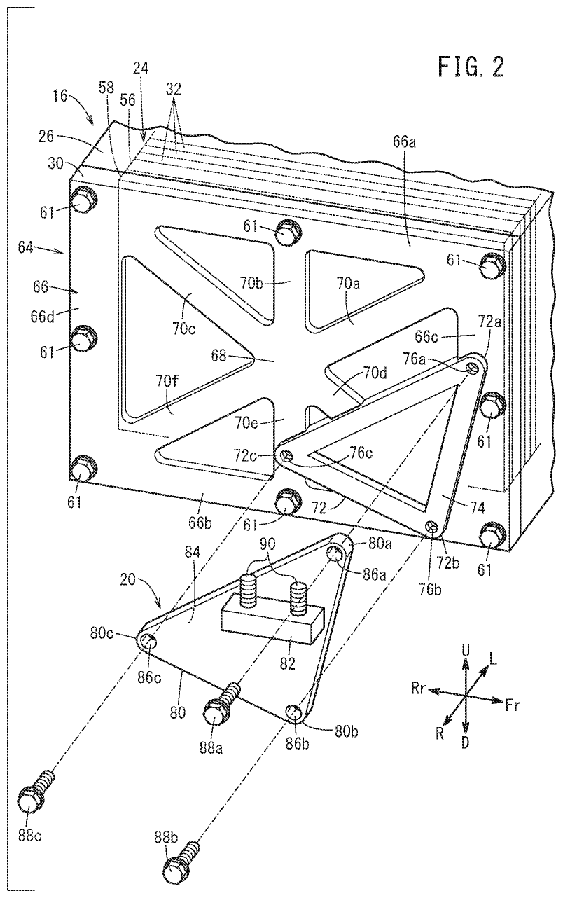

As shown in FIGS. 1 and 2, the stack case 26 has a quadrangular tubular shape extending along the vehicle widthwise direction. The stack case 26 covers the cell stack 24 from upper and lower directions and front and rear directions thereof. In FIG. 1, the auxiliary equipment case 28 is a protective case for protecting fuel cell auxiliary equipment 60, and is fixed to the one end (the end in the direction of the arrow L) of the stack case 26. A fuel gas system device and an oxygen-containing gas system device are accommodated as the fuel cell auxiliary equipment 60 inside the auxiliary equipment case 28.

As shown in FIGS. 1 and 2, the end plate 30 is fixed to the other end (the end in the direction of the arrow R) of the stack case 26 so as to close the opening at the other end of the stack case 26. Stated otherwise, the end plate 30 is fastened by a plurality of bolts 61 to the other end surface of the stack case 26. The end plate 30 applies a tightening load to the cell stack 24 in the stacking direction. Moreover, although omitted from illustration, a seal member made of an elastic material is disposed between the stack case 26 and the end plate 30 over the entire periphery of a joining surface between the stack case 26 and the end plate 30.

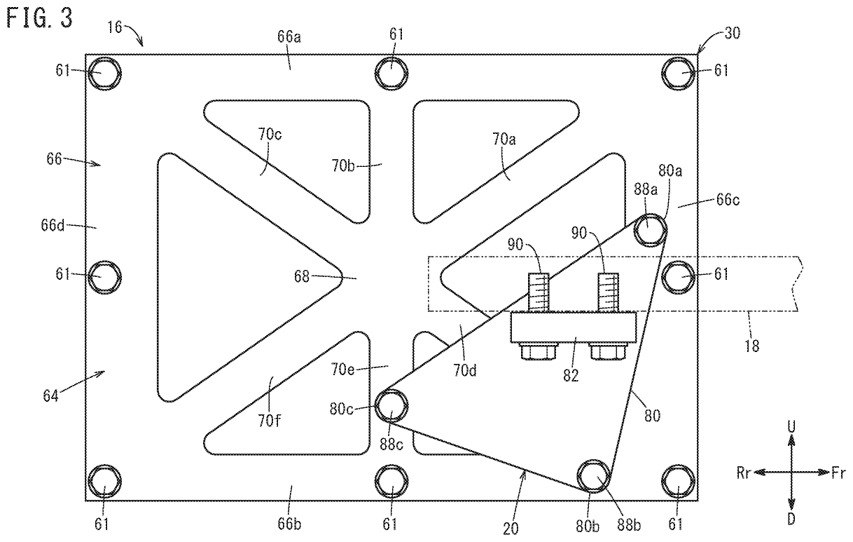

As shown in FIGS. 2 and 3, the end plate 30 is a rectangular metal plate having a horizontally elongate shape. The end plate 30 extends in a transverse direction of the end plate 30 (vehicle longitudinal direction) which is perpendicular to the stacking direction of the cell stack 24 and the vertical direction.

On an outer surface of the end plate 30 (an outer surface oriented in the direction of the arrow R), ribs 64 are provided that protrude outward (in a direction opposite to the stack case 26). The ribs 64 include an outer peripheral rib 66, a center rib 68, a first linear rib 70a, a second linear rib 70b, a third linear rib 70c, a fourth linear rib 70d, a fifth linear rib 70e, a sixth linear rib 70f, and a mounting rib 72.

The outer peripheral rib 66 extends once peripherally along an outer peripheral edge portion of the end plate 30. The outer peripheral rib 66 has a quadrangular annular shape (quadrangular frame shape). The outer peripheral rib 66 includes an upper rib 66a, a lower rib 66b, a first side rib 66c, and a second side rib 66d. The upper rib 66a extends over the entire length of the end plate 30 in the transverse direction (vehicle longitudinal direction) along the upper side of the end plate 30.

The lower rib 66b extends over the entire length of the end plate 30 in the transverse direction (vehicle longitudinal direction) along the lower side of the end plate 30. The first side rib 66c extends along the side of the end plate 30 on the vehicle front side (in the direction of the arrow Fr) over the entire length of the end plate 30 in the vertical direction. The second side rib 66d extends along the side of the end plate 30 on the vehicle rear side (in the direction of the arrow Rr) over the entire length of the end plate 30 in the vertical direction.

The center rib 68 is positioned substantially in a central portion of the outer surface of the end plate 30. Owing to this feature, it is possible for a central portion of the end plate 30, which can be easily deformed by a reaction force of the tightening load that acts on the cell stack 24, to be reinforced by the center rib 68.

The first linear rib 70a extends linearly from the center rib 68 to an upper corner portion (a connected location of the upper rib 66a and the first side rib 66c) on one end side (in the direction of the arrow Fr) of the end plate 30. The second linear rib 70b extends linearly along the direction of the arrow U from the center rib 68 to a central portion of the upper rib 66a in the vehicle longitudinal direction (in the transverse direction of the end plate 30). The third linear rib 70c extends linearly from the center rib 68 to an upper corner portion (a connected location of the upper rib 66a and the second side rib 66d) on another end side (in the direction of the arrow Rr) of the end plate 30.

The fourth linear rib 70d extends linearly from the center rib 68 to a lower corner portion (a connected location of the lower rib 66b and the first side rib 66c) on the one end side (in the direction of the arrow Fr) of the end plate 30. The fifth linear rib 70e extends linearly along the direction of the arrow D from the center rib 68 to a central portion of the lower rib 66b in the vehicle longitudinal direction (in the transverse direction of the end plate 30). The sixth linear rib 70f extends linearly from the center rib 68 to a lower corner portion (a connected location of the lower rib 66b and the second side rib 66d) on the other end side (in the direction of the arrow Rr) of the end plate 30.

In the manner described above, the first linear rib 70a, the second linear rib 70b, the third linear rib 70c, the fourth linear rib 70d, the fifth linear rib 70e, and the sixth linear rib 70f are formed on the end plate 30. Consequently, deformation of the end plate 30 due to the reaction force of the tightening load applied to the cell stack 24 can be further suppressed. Further, the first linear rib 70a, the second linear rib 70b, the third linear rib 70c, the fourth linear rib 70d, the fifth linear rib 70e, and the sixth linear rib 70f are connected to the center rib 68. Owing to this feature, the central portion of the end plate 30 can be further reinforced.

As shown in FIG. 2, the mounting rib 72 is positioned near one end in the transverse direction (closer to the vehicle front side) and on the lower side of the end plate 30. Stated otherwise, the mounting rib 72 is shifted more to one end side in the transverse direction (in the frontward direction of the vehicle, or on the vehicle front side) than the center of the end plate 30. The mounting rib 72 is formed in a triangular shape when viewed from the stacking direction (the direction of the arrow R) of the cell stack 24. A flat contact surface 74, which has a substantially triangular shaped outer periphery with a constant width that is contacted by the bracket 20, is formed on the mounting rib 72. The mounting rib 72 includes a first vertex 72a, a second vertex 72b, and a third vertex 72c.

A first screw hole 76a is formed in the first vertex 72a. The first vertex 72a protrudes outwardly (in the direction of the arrow R) from the first side rib 66c in the stacking direction of the cell stack 24. Consequently, the first vertex 72a in which the first screw hole 76a is formed can be reinforced by the first side rib 66c.

A second screw hole 76b is formed in the second vertex 72b. The second vertex 72b protrudes outwardly (in the direction of the arrow R) from the lower rib 66b in the stacking direction of the cell stack 24. Consequently, the second vertex 72b in which the second screw hole 76b is formed can be reinforced by the lower rib 66b.

A third screw hole 76c is formed in the third vertex 72c. The third vertex 72c protrudes outwardly (in the direction of the arrow R) from the fifth linear rib 70e in the stacking direction of the cell stack 24. Consequently, the third vertex 72c in which the third screw hole 76c is formed can be reinforced by the fifth linear rib 70e. The third screw hole 76c is located substantially at the center in the transverse direction of the end plate 30. Stated otherwise, the third screw hole 76c is located in proximity to (downwardly of) the center rib 68.

A fourth linear rib 70d is connected to the mounting rib 72. More specifically, the mounting rib 72 is connected to the center rib 68 via the fourth linear rib 70d. Consequently, the center rib 68 can be reinforced by the mounting rib 72. Thus, the central portion of the end plate 30 can be more effectively reinforced.

As shown in FIGS. 2 and 3, the bracket 20 serves to fix the fuel cell stack 16 with respect to the mounting member 18 (see FIG. 3) of the fuel cell vehicle 10. The bracket 20 is disposed with respect to the mounting rib 72 of the end plate 30. The bracket 20 is disposed on a portion that is near to the one end in the transverse direction (closer to the vehicle front side) and on the lower side of the end plate 30.

The bracket 20 is formed in a triangular shape when viewed from the stacking direction (the direction of the arrow R) of the cell stack 24. The bracket 20 includes a bracket main body 80, and a mount part 82 provided on the bracket main body 80. The bracket main body 80 is a triangular plate-shaped member. A substantially triangular shaped flat joining surface 84 (see FIG. 2), which contacts the contact surface 74 of the mounting rib 72, is formed on the bracket main body 80. The joining surface 84 is formed in a triangular shape corresponding to the shape of the bracket 20 as viewed from the stacking direction of the cell stack 24. The bracket main body 80 includes a first vertex 80a, a second vertex 80b, and a third vertex 80c.

In the first vertex 80a, a first insertion hole 86a is formed, through which there is inserted a first bolt 88a that is screw-engaged with the first screw hole 76a of the mounting rib 72. In the second vertex 80b, a second insertion hole 86b is formed, through which there is inserted a second bolt 88b that is screw-engaged with the second screw hole 76b of the mounting rib 72. In the third vertex 80c, a third insertion hole 86c is formed, through which there is inserted a third bolt 88c that is screw-engaged with the third screw hole 76c of the mounting rib 72. The first bolt 88a, the second bolt 88b, and the third bolt 88c are fastening members for fastening the bracket 20 with respect to the end plate 30. Consequently, the bracket 20 can be firmly attached to the end plate 30. Such a bracket 20 is also provided on the auxiliary equipment case 28.

Instead of using the fastening members (the first bolt 88a, the second bolt 88b, and the third bolt 88c), the bracket 20 may be joined (fastened) with respect to the end plate 30 by rivets, welding, brazing, caulking, or the like. Further, stud bolts may be provided on the side of the end plate 30, and fastening may be performed by way of nuts from the side of the bracket 20.

The mount part 82 protrudes from the bracket main body 80 toward the opposite side (in the direction of the arrow R) from the end plate 30. The mount part 82 is fastened by fixing bolts 90 with respect to the mounting member 18 of the fuel cell vehicle 10.

The fixing bolts 90 are positioned inwardly of the triangular shape that connects the first bolt 88a, the second bolt 88b, and the third bolt 88c, when viewed from the stacking direction (in the direction of the arrow R) of the cell stack 24. Owing to this feature, the fuel cell stack 16 can be firmly fixed to the mounting member 18 by the bracket 20. The number, size, and positions of the fixing bolts 90 may be set appropriately.

As shown in FIG. 1, a vehicle body component 92 (a brake component, a hydraulic cylinder, or the like) is disposed inside the front box 14 of the fuel cell vehicle 10 on a vehicle rear side of the bracket 20.

The first vertex 72a of the mounting rib 72 is provided integrally with the first side rib 66c. The first vertex 80a of the bracket main body 80 is fastened by the first bolt 88a to the first vertex 72a (and the first side rib 66c) of the mounting rib 72. Consequently, the first side rib 66c of the end plate 30 can be reinforced by the first vertex 72a of the mounting rib 72 and the first vertex 80a of the bracket main body 80.

The second vertex 72b of the mounting rib 72 is provided integrally with the lower rib 66b. The second vertex 80b of the bracket main body 80 is fastened by the second bolt 88b to the second vertex 72b (and the lower rib 66b) of the mounting rib 72. Consequently, the lower rib 66b of the end plate 30 can be reinforced by the second vertex 72b of the mounting rib 72 and the second vertex 80b of the bracket main body 80.

The first vertex 72a and the second vertex 72b of the mounting rib 72 are disposed on two different sides (the lower rib 66b and the first side rib 66c) of the outer peripheral rib 66. The first vertex 80a and the second vertex 80b of the bracket main body 80 are fastened by the first bolt 88a and the second bolt 88b to the two different sides (the lower rib 66b and the first side rib 66c) of the outer peripheral rib 66. Owing to this feature, deformation of the end plate 30 (deformation due to the reaction force of the tightening load applied to the cell stack 24) can be effectively suppressed.

The shape, the size, and the positions of the ribs 64 can be appropriately changed. The first vertex 72a and the second vertex 72b of the mounting rib 72 may protrude outwardly in the stacking direction of the cell stack 24 from one side (for example, the lower rib 66b or the first side rib 66c) of the outer peripheral rib 66. In this case, the first vertex 80a and the second vertex 80b of the bracket main body 80 are fastened by the first bolt 88a and the second bolt 88b to one side (for example, the lower rib 66b or the first side rib 66c) of the outer peripheral rib 66.

The third vertex 72c of the mounting rib 72 may protrude outwardly in the stacking direction of the cell stack 24 from the center rib 68. In this case, the third vertex 80c of the bracket main body 80 is fastened by the third bolt 88c to the third vertex 72c (and the center rib 68) of the mounting rib 72. Consequently, the center rib 68 can be more effectively reinforced by the mounting rib 72 and the bracket 20.

At least one of the outer peripheral rib 66, the first linear rib 70a, the second linear rib 70b, the third linear rib 70c, the fourth linear rib 70d, the fifth linear rib 70e, and the sixth linear rib 70f need not necessarily be formed on the end plate 30. Further, the ribs 64 need not necessarily be formed on the end plate 30.

In this case, the fuel cell vehicle 10 according to the present embodiment exhibits the following advantageous effects.

In the fuel cell vehicle 10, since the bracket 20 is provided on the end plate 30, the end plate 30 can be easily reinforced by the bracket 20.

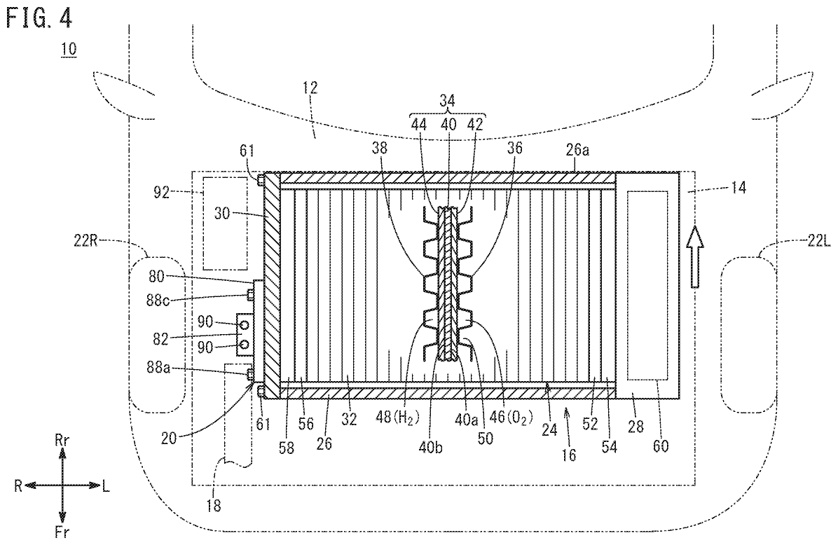

Further, as shown in FIG. 4, for example, when the fuel cell vehicle 10 is involved in a rear-end collision, the fuel cell stack 16 and the bracket 20 move relative to the vehicle body inside the front box 14 in the vehicle rearward direction (in the direction of the arrow Rr). In addition, a rear surface 26a of the stack case 26 of the fuel cell stack 16 moves toward the dashboard 12.

However, the bracket 20 is disposed at a portion that is near to the one end in the transverse direction (closer to the vehicle front side) and on the lower side of the end plate 30, together with being formed in a triangular shape when viewed from the stacking direction of the cell stack 24. Therefore, at the time of a rear-end collision of the fuel cell vehicle 10, the vehicle body component 92 can be positioned in a comparatively wide space on the vehicle rear side of the bracket 20 (on the other end side in the transverse direction of the end plate 30). Accordingly, interference between the bracket 20 and the vehicle body component 92 at the time of a rear-end collision (during a collision) of the fuel cell vehicle 10 can be effectively suppressed.

The bracket 20 is fastened with respect to the end plate 30 by fastening members (the first bolt 88a, the second bolt 88b, and the third bolt 88c). The fastening members (the first bolt 88a, the second bolt 88b, and the third bolt 88c) are disposed at the respective vertices (the first vertex 80a, the second vertex 80b, and the third vertex 80c) of the triangular shape of the bracket main body 80.

In accordance with such a configuration, the bracket 20 can be firmly and easily attached with respect to the end plate 30.

The fuel cell stack 16 is arranged inside the front box 14 provided on the vehicle front side of the dashboard 12, and the bracket 20 is provided for the end plate 30 near the vehicle front side. The vehicle body component 92 is arranged on the vehicle rear side of the bracket 20 inside the front box 14.

In accordance with such a configuration, at the time of a rear-end collision of the fuel cell vehicle 10, the vehicle body component 92 can be positioned in the comparatively wide space on the vehicle rear side of the bracket 20, and interference between the bracket 20 and the vehicle body component 92 can be suppressed.

The mounting rib 72 is formed on a portion of the end plate 30 that is contacted by the bracket 20.

In accordance with such a configuration, the portion of the end plate 30 to which the bracket 20 is attached can be reinforced.

The center rib 68 is formed in a substantially central portion of the end plate 30. The mounting rib 72 is connected to the center rib 68 via the intermediate ribs (the fourth linear rib 70d and the fifth linear rib 70e).

In accordance with such a configuration, it is possible for the central portion of the end plate 30, which can be easily deformed by a reaction force of the tightening load that acts on the cell stack 24, to be reinforced by the center rib 68. Further, the center rib 68 can be reinforced by the mounting rib 72.

The joining surface 84 of the bracket 20 that is joined to the end plate 30 is formed in a triangular shape corresponding to the shape of the bracket 20 as viewed from the stacking direction.

In accordance with such a configuration, the reaction force of the tightening load that acts on the cell stack 24 can be received by the joining surface 84 of the bracket 20. Consequently, the end plate 30 can be effectively reinforced. Thus, it becomes possible for the thickness of the end plate 30 to be kept relatively thin.

The present invention is not limited to the configuration described above. The mounting rib 72 may be formed to be larger than the bracket 20 when viewed from the stacking direction of the cell stack 24.

The present invention is not limited to the embodiments described above, and various modifications may be made thereto without deviating from the essential scope of the present invention as set forth in the appended claims.

The embodiment described above can be summarized in the following manner.

In the above described-embodiment, the fuel cell vehicle (10) is disclosed, the fuel cell vehicle (10) comprising the fuel cell stack (16) and the mounting bracket (20), the fuel cell stack (16) having the end plate (30) configured to apply the tightening load to the cell stack (24) including the plurality of power generation cells (32) that are mutually stacked, the tightening load being applied in the stacking direction of the cell stack (24), and the mounting bracket (20) being provided for the end plate (30), wherein the fuel cell stack (16) is disposed in a manner so that the stacking direction is oriented in a vehicle widthwise direction, the end plate (30) extends in a transverse direction, and the bracket (20) is disposed near one end in the transverse direction of the end plate (30) and at a portion on a lower side thereof, the bracket (20) being formed in a triangular shape when viewed from the stacking direction.

The bracket (20) may be fastened to the end plate (30) by the fastening members (88a to 88c), the fastening members (88a to 88c) being disposed at the respective vertices (80a to 80c) of the triangular shape.

The fuel cell stack (16) may be arranged inside the front box (14) provided on the vehicle front side of the dashboard (12), the bracket (20) may be provided for the end plate (30) near the vehicle front side, and the vehicle body component (92) may be arranged on the vehicle rear side of the bracket (20) inside the front box (14).

The mounting rib (72) may be formed on a portion of the end plate (30) that is contacted by the bracket (20).

The center rib (68) may be formed in a substantially central portion of the end plate (30), and the mounting rib (72) may be connected to the center rib (68) via the intermediate rib (70d, 70e).

The joining surface (84) of the bracket (20) that is joined to the end plate (30) may be formed in a triangular shape corresponding to the shape of the bracket (20) as viewed from the stacking direction.

What is claimed is:

1. A fuel cell vehicle comprising a fuel cell stack and a mounting bracket, the fuel cell stack having an end plate configured to apply a tightening load to a cell stack including a plurality of power generation cells that are mutually stacked, the tightening load being applied in a stacking direction of the cell stack, and the mounting bracket being provided for the end plate;
wherein the fuel cell stack is disposed in a manner so that the stacking direction is oriented in a vehicle widthwise direction;
the end plate extends in a transverse direction; and
the bracket is disposed near one end in the transverse direction of the end plate and at a portion on a lower side thereof, the bracket being formed in a triangular shape when viewed from the stacking direction.

2. The fuel cell vehicle according to claim 1, wherein the bracket is fastened to the end plate by fastening members, the fastening members being disposed at respective vertices of the triangular shape.

3. The fuel cell vehicle according to claim 1, wherein:
the fuel cell stack is arranged inside a front box provided on a vehicle front side of a dashboard;
the bracket is provided for the end plate near the vehicle front side; and
a vehicle body component is arranged on a vehicle rear side of the bracket inside the front box.

4. The fuel cell vehicle according to claim 1, wherein a mounting rib is formed on a portion of the end plate that is contacted by the bracket.

5. The fuel cell vehicle according to claim 4, wherein a center rib is formed in a substantially central portion of the end plate, and the mounting rib is connected to the center rib via an intermediate rib.

6. The fuel cell vehicle according to claim 1, wherein a joining surface of the bracket that is joined to the end plate is formed in a triangular shape corresponding to the shape of the bracket as viewed from the stacking direction.
